(19) United States
(12) Patent Application Publication
(10) Pub. No.: US 2026/0253194 A1
(43) Pub. Date: Aug. 27, 2026

(54) ANOMALY DETECTION IN AN AERONAUTICAL PART

(71) Applicant: SAFRAN, Paris (FR)

(72) Inventors: Jennifer VANDONI, MOISSY-CRAMAYEL (FR); Sofia MARINO, MOISSY-CRAMAYEL (FR)

(73) Assignee: SAFRAN, Paris (FR)

(21) Appl. No.: 19/489,701

(22) PCT Filed: May 30, 2024
(86) PCT No.: PCT/FR2024/050687

§ 371 Date: Dec. 3, 2025

(30) Foreign Application Priority Data
Jun. 8, 2023 (FR) FR2305806

(51) Int. Cl. G06T 7/00; G06V 10/25; G06V 10/762; G06V 10/764; G06V 10/774; G06V 10/82

(52) U.S. Cl. CPC G06T 7/0002; G06V 10/25; G06V 10/762; G06V 10/764; G06V 10/774; G06V 10/82; G06T 2207/20081; G06T 2207/20084

(57) ABSTRACT

A method for detecting an anomaly in a plurality of predefined zones of a single aeronautical component includes supplying an image to be inspected to a detection system that includes a backbone neural network configured to supply an intermediate representation of the image to be inspected, and localisation neural networks that are respectively associated with the zones and each designed, on the basis of the intermediate representation, to search for one or more anomalies and to locate each anomaly found in the image to be inspected. The detection system has been previously trained, for each zone, by a step of supplying, to the backbone network, training images, and, on the basis of the training images of the relevant zone, an adaptive adjustment step during which parameters of the backbone network and of the localisation network that is associated with the relevant zone are adjusted.

### TECHNICAL FIELD OF THE INVENTION

The present invention relates to a method for detecting anomalies in several predefined areas of a part, an associated computer program and an anomaly detection device.

This invention relates in particular to the field of non-destructive testing of parts, especially aeronautical parts.

### TECHNICAL BACKGROUND

In the US patent application published under the number US 2011 0182495 A1, conventional descriptors characterizing the texture of the part (wavelet analysis) are used, and an image deviation value is calculated in relation to an image with reference texture of the healthy part, to detect any anomalies without any statistical method. However, this approach has limitations because it requires a reference texture to be obtained, which may be difficult due to the complexity and heterogeneity of the geometry of the part itself. So, to process different areas of the part, different mathematical models would have to be established with different textures for the different areas.

In the US patent published under the number U.S. Pat. No. 8,238,635 B2, a test image is compared with a healthy reference image (which may be obtained by averaging several healthy images). An elastic or rigid recalibration to superimpose the two images and calculate the residual image (subtraction of the two recalibrated images) is performed beforehand. The disadvantage of this solution is that it requires recalibration, which is a fairly costly operation. In addition, processing the residual image is complicated as soon as the image acquisition conditions (sensor luminosity, etc.) change slightly.

In the US patent application published under the number US 2009 0066939 A1, instead of using statistical learning, descriptors are designed manually to detect each type of defect sought, for example by exploiting the Hough transform for straight line search, or connected filters for shape filtering. This approach is clearly not optimal in the presence of very heterogeneous anomalies and areas of the part.

In the French patent application published under the number FR 3 058 816, automatic statistical learning is proposed. Firstly, the image acquired using an X-ray generator is cut into several thumbnails. The thumbnails are then automatically classified with a label representing the presence of anomalies in the thumbnail. The disadvantage of this solution is that the images have to be cut into small thumbnails and then reconstructed. Moreover, this solution may not pinpoint the exact localization of any anomalies.

It may therefore be desirable to provide an anomaly detection method which avoids at least some of the above problems and constraints.

### SUMMARY OF THE INVENTION

A method is therefore proposed for detecting an anomaly in several predefined areas of a single part such as a vane, the areas having different structures such as different geometries and/or different materials and/or different thicknesses and/or the presence or absence of a cavity and/or cavities of different sizes, each area being associated with at least one predefined view of this area, characterized in that it comprises:
obtaining an image, referred to as the image to be inspected, of one of the areas according to one of the predefined views of this area;
supplying the image to be inspected to a detection system comprising:
   a backbone neural network designed to receive the image to be inspected and to supply an intermediate representation of the image to be inspected, and
   localization neural networks, respectively associated with the areas, and each designed, from the intermediate representation, to search for one or more anomalies and to localize each anomaly found in the image to be inspected;
the detection system having been previously trained, for each area, by: supplying the backbone network with training images according to each predefined view of the area in question, and, from the training images of the area in question, an adaptive adjustment during which parameters of the backbone network and of the localization network associated with the area in question are adjusted, but not parameters of the one or more other localization networks, in order to improve detection and the localization; and
obtaining the one or more anomalies and their localization at the output of the localization network associated with the area of the image to be inspected.

Thus, compared with the US patent application US 2011 0182495 A1, the invention only requires a single trained detection system (with the localization networks respectively dedicated to the areas), which avoids establishing several mathematical models. Compared with the U.S. Pat. No. 8,238,635 B2, the invention does not require the image to be tested to be compared with a reference image in order to calculate the residual image, since once the detection device has been trained, it simply needs to be supplied with the image to be tested. Compared with the US patent application US 2009 0066939 A1, the invention uses neural networks to avoid the need to define descriptors manually. Compared with the French patent application FR 3 058 816, the detection device receives and processes the image to be tested in its entirety, and therefore does not require a step to cut out the image to be tested.

The invention may further comprise one or more of the following additional characteristics, in any technically possible combination.

In practice, each localization network is associated with several reference boxes and each localization network is designed to supply, on the one hand, a position, in the image to be inspected, of one of the reference boxes of the area represented on the image to be inspected and, on the other hand, a probability of presence of an anomaly in the reference box at this position.

In this way, a more precise localization may be achieved than with the prior networks mentioned above. These prior art networks are classification networks using activation maps of neural areas, these neural areas being respectively associated with very general portions of the image. This means that they may only be used to localize general portions, which is much less accurate than using boxes.

In practice too, the reference boxes are different for at least one of the localization networks with respect to the one or more other localization networks, for example in number and/or size.

Also in practice, the method further comprises, for each area: —determining, in the training images representing the area under consideration, boxes surrounding each anomaly previously found in the training images; —clustering the boxes into several clusters of similar boxes; and —for each cluster found, determining a reference box from the boxes in the cluster.

Also in practice, the determined reference box has dimensions derived from the dimensions of the boxes in the cluster.

Also in practice, the method comprises, for each predefined area, a classification network designed to classify, in predefined classes, the anomalies found by the localization network associated with the area in question.

Also in practice, the part is a vane comprising a root and a blade, and wherein the predefined areas are formed by the root and the blade.

Also in practice, the blade has one or more cavities defining a certain percentage of void with respect to the total volume of the blade, this percentage of void being greater than that of the root, it being possible for the percentage of void of the root to be zero, meaning that there is no cavity.

Also in practice, the blade and the root have different thicknesses.

Also proposed is a computer program that may be downloaded from a communications network and/or recorded on a computer-readable medium, characterized in that it comprises instructions for executing the steps of an anomaly detection method according to the invention, when said program is executed on a computer.

Also proposed is an anomaly detection system, characterized in that it comprises:
a backbone neural network designed to receive an image to be inspected and to supply an intermediate representation of the image to be inspected, and
localization neural networks respectively associated with predefined areas of a single part such as a vane, each area being associated with at least one predefined view of this area, the areas having different structures such as different geometries and/or different materials and/or different thicknesses and/or the presence or the absence of a cavity and/or cavities of different sizes, and each designed, from the intermediate representation, to search for one or more anomalies and to localize each anomaly found in the image to be inspected;
the detection device having been previously trained, for each area, by:
a supply, to the backbone network, of training images according to each predefined view of the area in question, and
from the training images of the area in question, an adaptive adjustment during which parameters of the backbone network and of the localization network associated with the area in question are adjusted, but not parameters of the one or more other localization networks, in order to improve the detection and the localization.

### BRIEF DESCRIPTION OF THE FIGURES

The invention will be better understood with the aid of the following description, given only by way of example and made with reference to the attached drawings wherein:

FIG. 1 is a perspective view of a vane that may form a part to be inspected,

FIG. 2 is a perspective view of a system for acquiring images of parts to be inspected,

FIG. 3 is a block diagram of a device for detecting an anomaly in a part to be inspected,

FIG. 4 is a block diagram of a method for detecting an anomaly in a part to be inspected,

FIG. 5 is similar to FIG. 1, and also illustrates two areas of the vane, namely a root and a blade,

FIG. 6 shows an example of training images for training the anomaly detection device,

FIG. 7 shows the training images from FIG. 6, annotated to define boxes surrounding anomalies,

FIG. 8 is a graph illustrating, for each of the two areas of the vane, the dimensions of the boxes in the training images and the reference boxes determined by clustering,

FIG. 9 illustrates an example of the division of training images into two batches,

FIG. 10 is similar to FIG. 3 and illustrates the operation of the detection device during a learning phase based on the training images of the first batch in FIG. 9 illustrating the first area,

FIG. 11 is similar to FIG. 3 and illustrates the operation of the detection device during a learning phase based on the training images of the first batch in FIG. 9 illustrating the second,

FIG. 12 is similar to FIG. 3, and illustrates the operation of the detection device during a learning phase,

FIG. 13 is an image of an area of a vane to be inspected,

FIG. 14 is similar to FIG. 3 and illustrates the operation of the detection device during a prediction phase on the image in FIG. 13, and

FIG. 15 is a block diagram of a computer system implementing the detection device shown in FIG. 3.

### DETAILED DESCRIPTION OF THE INVENTION

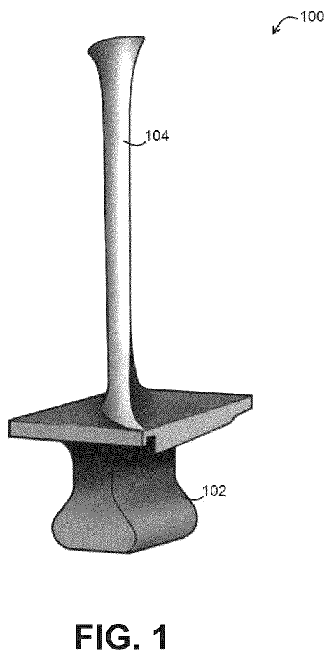

With reference to FIG. 1, a vane 100 that may form a part to be inspected in accordance with the invention comprises a root 102 and a blade 104. The vane 100, for example, belongs to a fan of a turbomachine of an aircraft.

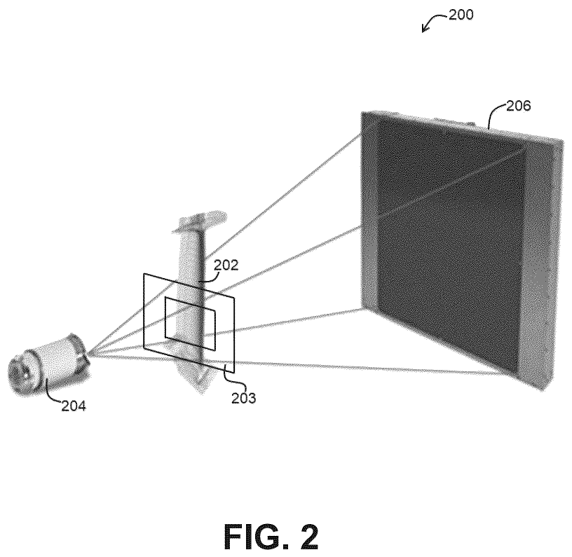

With reference to FIG. 2, an example of a system 200 for acquiring an image of a part 202, such as the vane 100 of FIG. 1, will now be described.

The acquisition system 200 firstly comprises an X-ray generator 204 designed to generate a cone of X-rays bombarding the part 202. The acquisition system 200 may also comprise a collimator 203 attached at the output of the generator 204 to limit the cone of X-rays. In this way, there is less X-ray dispersion likely to cause scattering. The acquisition system 200 also comprises a detector 206 placed behind the part 202 and designed to determine an attenuation of the X-rays, in order to supply a two-dimensional image, sometimes called a “projection”. This image is, for example, in grey levels proportional to the attenuation of the X-rays passing through the part 202.

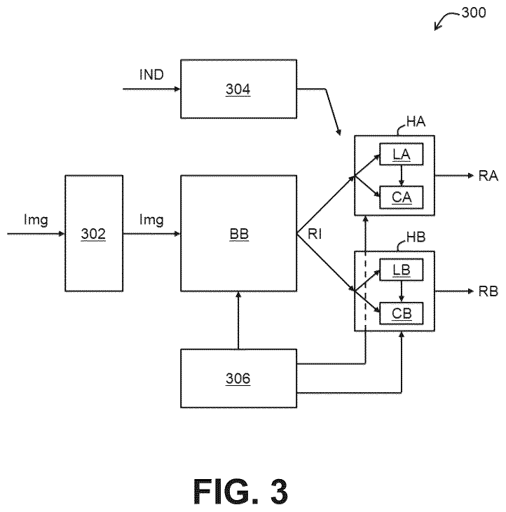

With reference to FIG. 3, an example of a system 300 for detecting an anomaly in a part, such as the vane 100 of FIG. 1, will now be described.

The detection system 300 may firstly comprise an image processing module 302. The latter is designed to receive an image to be inspected Img and to carry out one or more image processing operations on it. The processed image will then also be referred to as the image to be inspected and given the same reference Img. The image to be inspected, Img, represents one of Z predefined part areas. The definition of these areas will be described in more detail below.

A first possible process is filtering designed to enhance the characteristic patterns of anomalies and reduce image noise.

A second possible process is masking around a region of interest in the image. This masking is achieved, for example, by automated detection of the air and the collimator 203, for example by automatically calculating an optimum grey level threshold allowing the part to be separated from the air and the collimator 203.

A third possible operation is to normalize the data in order to facilitate and achieve faster convergence of the learning process, which will be described later. For example, the normalization is carried out to obtain a mean of 0 and a standard deviation of 1 for the grey levels of the image to be inspected.

The detection system 300 also comprises a convolutional neural network called backbone BB. The latter is designed to receive the image to be inspected Img (after processing if one or more image processes are planned) and to supply an intermediate representation RI of the image to be inspected Img.

The detection system 300 also comprises heads Hz (1≤z≤Z), respectively associated with the areas z.

Each head Hz comprises a localization neural network Lz, designed, from the intermediate representation RI, to search for one or more anomalies and to localize each anomaly found in the image to be inspected Img, when the latter represents the associated area z.

Each head Hz may also comprise a classification neural network Cz, designed, from the intermediate representation RI, to classify each anomaly found by the localization network Lz.

Each head Hz is thus designed to supply a prediction result Rz comprising the localization determined by the localization network Lz and, where applicable, the classification determined by the classification network Cz.

The detection system 300 may also comprise a selection module 304, but this is not mandatory. The latter is then designed to receive an indication IND of the area z that the image to be inspected Img represents and to deactivate the head or heads associated with areas other than that indicated by the indication IND received.

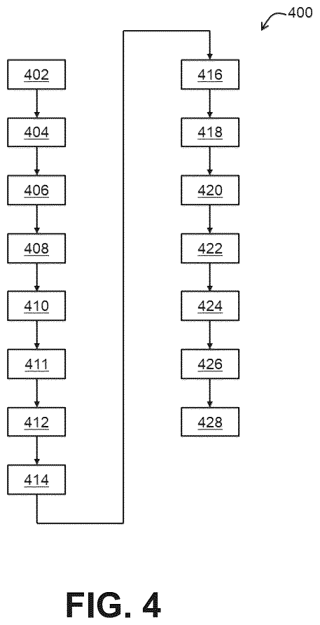

The detection system 300 further comprises a training module 306 designed to adjust parameters ϑ_{BB} of the backbone network BB and, for each head Hz, parameters ϑ_{Lz} of the localization network Lz and, where applicable, parameters ϑ_{Cz} of the classification network Cz. This adjustment is made during a learning phase which will be described later. With reference to FIG. 4, an anomaly detection method 400 according to the invention will now be described.

The method 400 comprises firstly the learning phase mentioned above, which comprises the following steps.

In a step 402, the areas z are defined. An area z is a portion of a part, in particular a homogeneous part, for example with a particular geometry and/or material.

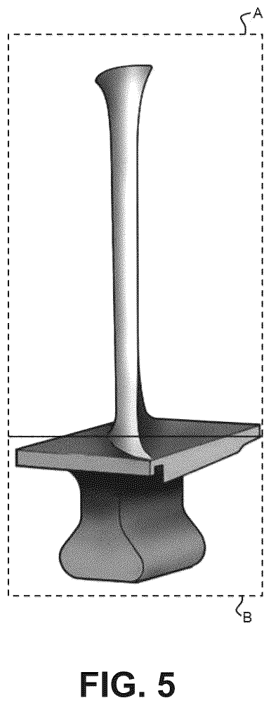

The areas z are areas of the same part, for example a vane like the one shown in FIG. 1. In the latter case, a first area z=A may be the root of the vane and a second area z=B may be the blade of the vane, as shown in FIG. 5. The choice of the different areas z is made, for example, taking into account the heterogeneity of the part to be inspected, i.e. the geometric and physical specificities linked to the different areas of the part. The areas z therefore have different structures. By “different structures” we mean, for example: different geometries and/or different materials and/or different thicknesses and/or the presence or absence of a cavity and/or cavities of different sizes. For example, a vane root generally has few cavities, unlike the blade. The blade thus has a certain percentage of empty space in relation to its total volume due to the presence of one or more cavities. The root also has a certain percentage of empty space in relation to its total volume (which may be zero if there is no cavity). The percentage void in the blade is then greater than the percentage void in the root, for example by at least 10%.

In a step 404, for each area z, one or more views of the area z in question are defined. In the following, it will be assumed that a single view is defined for each area z.

In a step 406, training images I* are obtained. These training images I* are taken from several training parts, for each view of each area z.

For example, the acquisition system 200 is used to acquire the training images I*. Each training image I* is preferably obtained from several projections of the same part, from the same view, for example by averaging these projections. This reduces the acquisition noise.

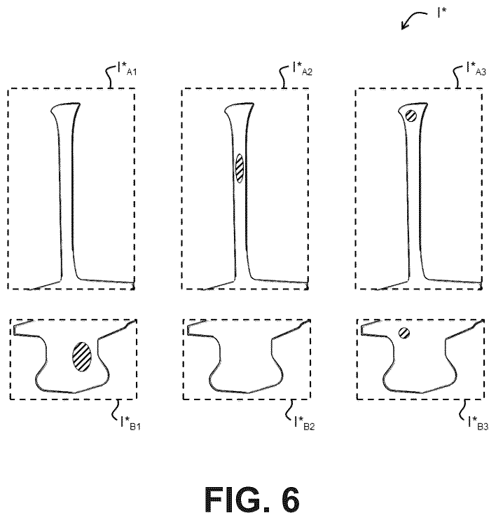

In FIG. 6, an example of training images I*_{A1}, I*_{A2}, I*_{A3}, I*_{B1}, I*_{B2}, I*_{B3} is shown, with the areas z=A and z=B of FIG. 5. The hatched areas on these training images I*_{A1}, I*_{A2}, I*_{A3}, I*_{B1}, I*_{B2}, I*_{B3} represent anomalies. Of course, in practice, the number of training images I* will be much higher.

During a step 408, the training images I* may be processed by the processing module 302, in order to facilitate analysis by the detection device 300.

In a step 410, one or more anomalies are searched for in each training image I* and each anomaly found is localized. This step is carried out by a human operator, for example.

For example, the localization of each anomaly found comprises a definition of a box, referred as an annotated box BOI*, which is rectangular and encompasses the anomaly found. This definition comprises, for example, a height and a width of the annotated box BOI*, and a position of the annotated box BOI* in the training image I*.

Each anomaly found may also be classified by the human operator according to a predefined classification (for example: inclusion, extra thickness, residue, extra thickness, etc.).

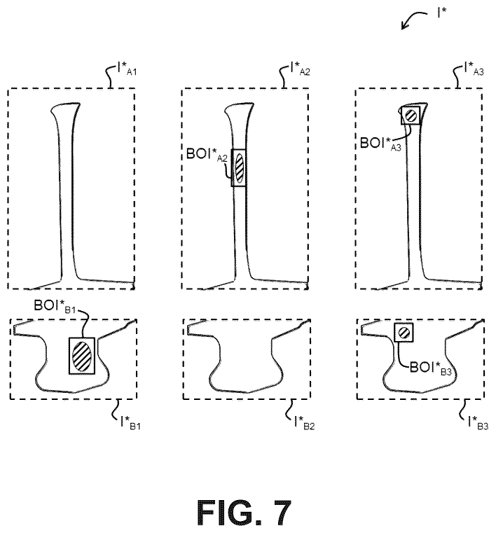

For example, with reference to FIG. 7, the human operator defines the annotated boxes BOI*_{A2}, BOI*_{A3}, BOI*_{B1}, BOI*_{B3} around the anomalies of the training images I*_{A2}, I*_{A3}, I*_{B1}, I*_{B3}, respectively.

The training images I* are preferably representative of the variability of the parts to be inspected and of the different homogeneous areas of the part to be inspected. The number of training images with anomalies must be sufficient to be able to teach the detection device 300 characteristics representative of each anomaly.

In order to create diversity in the training images I*, it is possible, during a step 411, to add transformations to at least some of the training images I* (for example, rotations, addition of noise or blur, modification of contrast, change of brightness, cropping, etc.).

At the end of step 410 and, if necessary, step 411, a training database is thus obtained comprising the training images I* and, for each of them: an indication IND of the area z represented on the training image and a training result comprising, for each anomaly found, a localization of this anomaly with possibly a classification of this anomaly in the case where the anomalies are classified. As explained above, the localization comprises, for example, an annotated box BOI* encompassing the anomaly found.

In an additional step 412, reference boxes AN (usually referred by anchors) are determined for each area z. The reference boxes are preferably different from one area z to another. Each reference box AN is characterized by its dimensions, for example a height and a width.

To determine the reference boxes AN, the dimensions of the annotated boxes BOI* associated with at least some of the training images I* of each area z are for example clustered (clustering) to obtain one or more clusters of similar dimensions of the annotated boxes BOI*. For example, K-means clustering is carried out. A reference box AN is then associated with each of the clusters found, with dimensions derived from the dimensions of the cluster in question, for example by taking a centroid of the cluster in question.

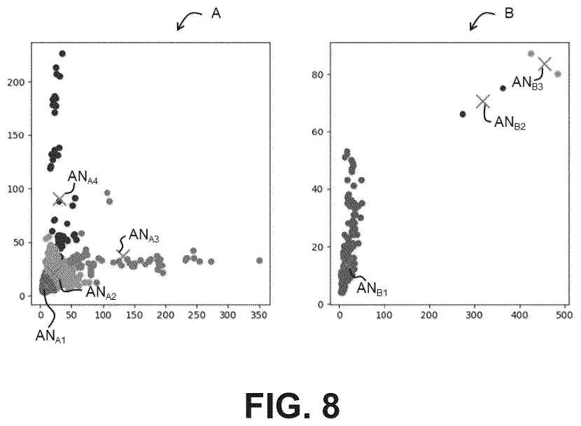

For example, with reference to FIG. 8, where the box width is on the x-axis and the box height on the y-axis, the clustering may give four clusters for the area A (blade of vane), i.e. four reference boxes AN_{A1}, AN_{A2}, AN_{A3}, AN_{A4}, and three clusters for the area B (vane roots), i.e. three reference boxes AN_{B1}, AN_{B2}, AN_{B3}.

In a step 414, the detection system 300 is trained by supervised learning from the training images I* and the associated training results. To do this, each training image I* is supplied to the backbone network BB and the training module 306 adjusts the parameters ϑ_{BB} of the backbone network BB and of the head Hz associated with the area z represented on the training image I* in question, to improve detection and localization in this area z. However, the parameters of the other head or heads are not adjusted from the training image I* in question. In this way, the parameters ϑ_{Lz}, ϑ_{Cz} of the heads Hz are adjusted with their associated z-area training images respectively. In other words, the other heads are left unchanged.

For example, the first aim of the training is to associate, with each annotated box BOI* surrounding an anomaly in the training image I*, a reference box AN from among those associated with the area z represented in the training image I* and a position of this reference box AN, so that the reference box AN at this position is close to the annotated box BOI*. For example, the training also aims to associate, with each annotated box BOI* surrounding an anomaly in the training image I*, a high probability of anomaly in the repositioned reference box AN, as well as the annotated anomaly class when classes are used.

It will be appreciated that no predefined function is provided for the backbone network BB, nor any predefined form or meaning for the intermediate representation RI. It is during training that the backbone network BB acquires a certain function, which has not been made explicit. Put another way, the output of the backbone network BB forms a hidden layer of the complete network (backbone network BB and head networks Hz) and the intermediate representation RI, also called hidden representation, comprises internal characteristics or abstract concepts that the complete network learns as it is trained.

Unlike the method described in the French patent application published under the number FR 3 058 816 A1, which carries out an image paving to work on thumbnails, each training image is supplied in its entirety to the backbone network BB. This is particularly advantageous in terms of calculation time, as a single pass through the detection system 300 is sufficient to obtain a prediction on the complete training image. In addition, there is no need for a post-processing step to assemble the predictions obtained on each thumbnail.

For example, the parameters are adjusted iteratively, for example by batch of training images, and the parameters are adjusted, for example, by a gradient descent algorithm. As is well known, a gradient descent algorithm may be used to find the minimum of any convex function by gradually converging towards it.

Thus, when batches are used, the training images I* are divided into batches Kj (1≤j≤J), each batch Kj being able to comprise training images from different areas z.

The training images I* of each batch Kj are then successively supplied to the input of the detection device 300 to obtain the respective prediction results Rj. These prediction results Rj are compared with the training results of the training images of the batch Kj. From this comparison, a partial detection loss function

$${𝒥}_{j}^{Lz} ( {ϑ}_{BB} , {ϑ}_{Lz} )$$

and, if applicable, a partial classification loss function

$${𝒥}_{j}^{Cz} ( {ϑ}_{BB} , {ϑ}_{Cz} ) ,$$

are determined for the batch Kj in question and for each area z.

The partial detection loss functions

$${𝒥}_{j}^{Lz} ( {ϑ}_{BB} , {ϑ}_{Lz} )$$

of the same area z are then combined, for example added together, to obtain a detection loss function J^{Lz}(ϑ_{BB},ϑ_{Lz}) for the detection network Lz of each area z. The detection loss function J^{Lz}(ϑ_{BB},ϑ_{Lz}) is, for example, the loss function L1 or the smooth loss function L1.

If necessary, in a similar way, the partial classification loss functions

$${𝒥}_{j}^{Lz} ( {ϑ}_{BB} , {ϑ}_{Cz} )$$

of the same area z are then combined, for example added together, to obtain a classification loss function J^{Cz}(ϑ_{BB},ϑ_{Cz}) for the classification network Cz of each area z. The classification loss function J^{Cz}(ϑ_{BB},ϑ_{Cz}) is, for example, the cross-entropy loss function or the focal loss function.

Thus, noting Z the total number of areas z, 2×Z loss functions are determined: Z loss functions for localization and Z loss functions for classification.

Then, for each area z, the parameters ϑ_{BB} of the backbone network BB, the parameters ϑ_{Lz} of the detection network Lz and, if applicable, the parameters ϑ_{Cz} of the classification network Cz of the head Hz are updated from the loss functions J^{Lz}(ϑ_{BB},ϑ_{Lz}) and J^{Cz}(ϑ_{BB},ϑ_{Cz}) determined. For example, the gradient descent algorithm uses the following equation for each area z: [Math. 1] (ϑ_{BB},ϑ_{Lz},ϑ_{Cz})ₜ₊₁=(ϑ_{BB},ϑ_{Lz},ϑ_{Cz})ₜ−Δ∇_{ϑ}(J^{LZ}(ϑ_{BB},ϑ_{Lz})+J^{Cz}(ϑ_{BB},ϑ_{Cz})).

In this way, each training image I* participates in the generation of the loss function or functions J^{Lz}(ϑ_{BB},ϑ_{Lz}) and J^{Cz}(ϑ_{BB},ϑ_{Cz}) associated with the area z represented on this training image I*. Thus, by using these loss functions to update the parameters, the parameters ϑ_{BB} of the backbone network BB are adjusted from each training image I*, whatever the area z represented, while only the parameters ϑ_{Lz}, ϑ_{Cz} of the head Hz associated with the area z represented on the training image I* are adjusted, and not the parameters of the where of the other heads.

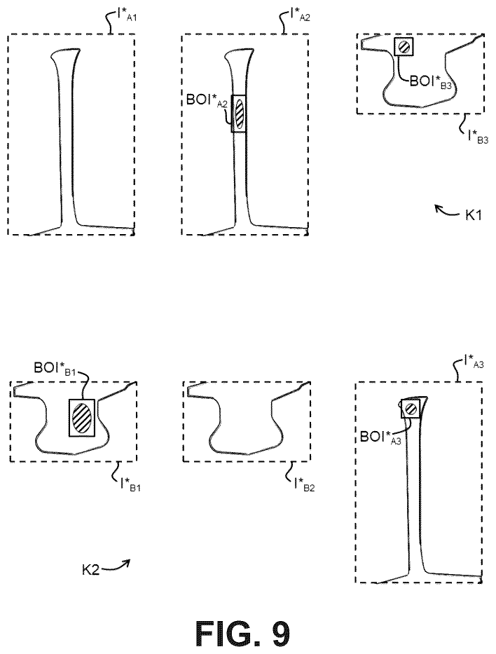

For example, with reference to FIG. 9, a first batch K1 comprises the training images I*_{A1}, I*_{A2}, I*_{B3} and a second batch K2 comprises the training images I*_{B1}, I*_{B2}, I*_{A3}.

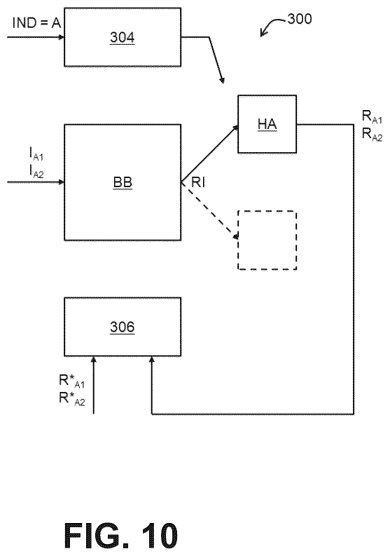

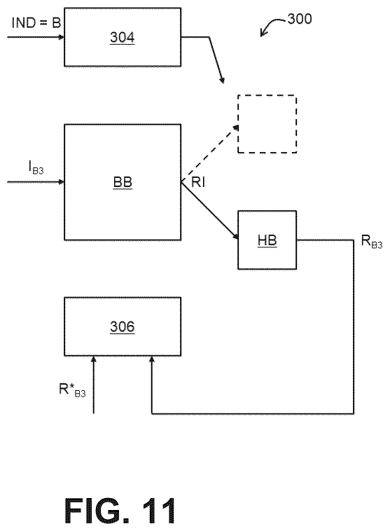

The training images I*_{A1}, I*_{A2}, I*_{B3} of the first batch K1 are thus first supplied to the detection device 300. Referring to FIG. 10, for training images I*_{A1}, I*_{A2}, the head HA then supplies the results R_{A1}, R_{A2}. With reference to FIG. 11, for the training image I*_{B3}, the head HB then supplies the result R_{B3}. From the results R_{A1}, R_{A2}, R_{B3}, the following partial loss functions are determined:

$${𝒥}_{1}^{LA} ( {ϑ}_{BB} , {ϑ}_{LA} ) {𝒥}_{1}^{CA} ( {ϑ}_{BB} , {ϑ}_{CA} ) , {𝒥}_{1}^{LB} ( {ϑ}_{BB} , {ϑ}_{LB} ) and {𝒥}_{1}^{CB} ( {ϑ}_{BB} , {ϑ}_{CB} ) .$$

In the same way, the training images I*_{B1}, I*_{B2}, I*_{A3} of the second batch K2 are supplied to the detection system 300 to obtain the results R_{B1}, R_{B2}, R_{A3} and, from them, the partial loss functions

$${𝒥}_{2}^{LA} ( {ϑ}_{BB} , {ϑ}_{LA} ) , {𝒥}_{2}^{CA} ( {ϑ}_{BB} , {ϑ}_{CA} ) and {𝒥}_{2}^{LB} ( {ϑ}_{BB} , {ϑ}_{LB} ) and {𝒥}_{2}^{CB} ( {ϑ}_{BB} , {ϑ}_{CB} ) .$$

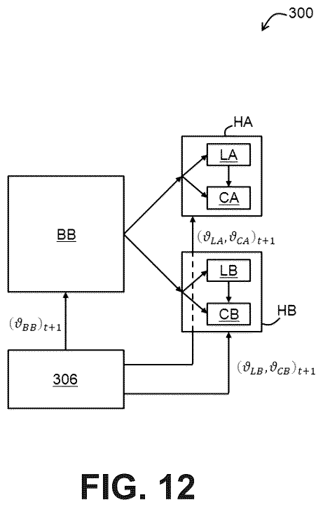

With reference to FIG. 12, the loss functions

$${𝒥}^{LA} ( {ϑ}_{BB} , {ϑ}_{LA} ) = {𝒥}_{1}^{LA} ( {ϑ}_{BB} , {ϑ}_{LA} ) + {𝒥}_{2}^{LA} ( {ϑ}_{BB} , {ϑ}_{LA} ) , {𝒥}_{}^{LB} ( {ϑ}_{BB} , {ϑ}_{LA} ) = {𝒥}_{1}^{LB} ( {ϑ}_{BB} , {ϑ}_{LA} ) + {𝒥}_{2}^{LB} ( {ϑ}_{BB} , {ϑ}_{LA} ) , {𝒥}_{}^{CA} ( {ϑ}_{BB} , {ϑ}_{LA} ) = \\ {𝒥}_{1}^{CA} ( {ϑ}_{BB} , {ϑ}_{LA} ) + {𝒥}_{2}^{CA} ( {ϑ}_{BB} , {ϑ}_{LA} ) and {𝒥}^{CB} ( {ϑ}_{BB} , {ϑ}_{CB} ) = {𝒥}_{1}^{CB} ( {ϑ}_{BB} , {ϑ}_{CB} ) + {𝒥}_{2}^{CB} ( {ϑ}_{BB} , {ϑ}_{CB} )$$

are then used to update the parameters ϑ_{BB}, ϑ_{LA}, ϑ_{LB}, ϑ_{CA}, ϑ_{CB} of the detection system 300, for example according to the equation [Math. 1].

A new training iteration may then begin, again supplying the training images I* to the detection system 300.

The method 400 then comprises a prediction phase.

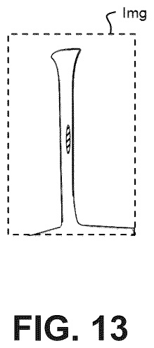

During a step 416, an image to be inspected Img is obtained, for example by means of the acquisition system 200. This image to be inspected Img represents one of the areas z according to one of the predefined views of this area z. For example, as shown in FIG. 13, the image to be inspected Img represents the blade (area A) of a vane, according to the single view predefined for the blade.

In a step 418, the image to be inspected Img should preferably be processed in the same way as the training images I* by the processing module 302.

In a step 420, the image to be inspected Img is supplied to the detection system 300, possibly after processing.

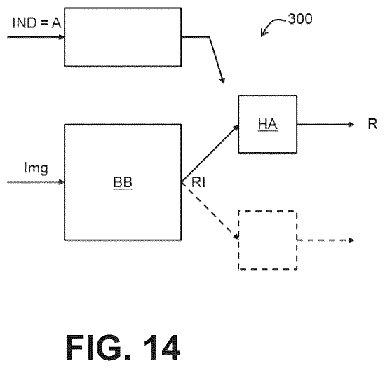

In a step 422, when the selection module 304 is present, the area z represented on the image to be inspected Img is indicated to the selection module 304, which deactivates, for example, the head or heads associated with the area or the areas other than the one indicated. For example, as shown in FIG. 14, the area A is indicated to the selection module 304. In response, the latter deactivates the head HB and leaves the head HA active. In the absence of the selection module 304, all the heads inspect the image to be inspected Img, for example, but only the output of the head associated with the area of the image to be inspected Img is relevant. The outputs of the other heads are not likely to be of interest and may be rejected.

In a step 424, the backbone network BB supplies an intermediate representation RI of the image to be inspected Img.

During a step 426, the head Hz associated with the area z represented on the image to be inspected Img searches for one or more anomalies and localizes each anomaly found, from the intermediate representation RI.

During a step 428, a result R of this search and of this localization is retrieved at the output of the head Hz associated with the area z represented on the image Img to be inspected.

For example, the result R comprises, for each reference box AN associated with the area z represented on the image to be inspected Img, a position of this reference box AN in the image Img and a probability of the presence of an anomaly in this reference box AN. An anomaly may therefore be considered to have been found when this probability is greater than a predefined threshold.

The heads Hz may also be designed to carry out a segmentation of each anomaly found, i.e. a classification of each pixel of the reference box AN containing this anomaly, for example according to two values: one value indicating a pixel with anomaly and another value indicating a pixel without anomaly. This segmentation is achieved, for example, by adding a segmentation neural network to each head, which is trained in a similar way to the detection Lz and classification Cz networks.

The prediction phase may be repeated for several parts to be inspected, for example several vanes to be inspected.

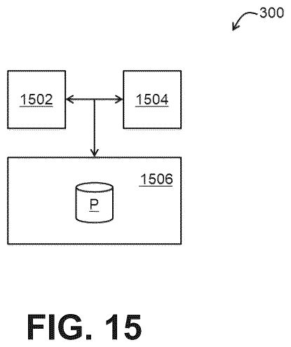

With reference to FIG. 15, the detection device 300 is, for example, a computer system comprising a data processing unit 1502 (such as a microprocessor) and a main memory 1504 (such as a RAM memory) accessible by the processing unit 1502. The computer system also comprises, for example, a network interface and/or a computer-readable medium, such as a local medium 1506 (such as a local hard disk) or a remote medium (such as a remote hard disk accessible via the network interface through a communications network) or a removable medium (such as a USB key, Universal Serial Bus”, or a “Compact Disc” CD or a “Digital Versatile Disc” DVD) that may be read by an appropriate computer system drive (such as a USB port or a CD and/or DVD drive). A computer program P containing instructions for the processing unit 1502 is stored on the local medium 1506 and/or may be downloaded via the network interface. This computer program P is, for example, configured to be loaded into the main memory 1504, so that the processing unit 1502 may execute its instructions. For example, the instructions are organized into software modules implementing the respective elements of the detection device 300, as described with reference to FIG. 3.

Alternatively, all or some of these modules may be implemented in the form of hardware modules, i.e. in the form of an electronic circuit, for example micro-wired, not involving a computer program.

In conclusion, it should be noted that the invention is not limited to the embodiments described above. In fact, it will appear to the person skilled in the art that various modifications may be made to the above-described embodiments, in the light of the teaching just disclosed.

In the foregoing detailed presentation of the invention, the terms used should not be interpreted as limiting the invention to the embodiments exposed in the present description, but should be interpreted to include all equivalents the anticipation of which is within the reach of the person skilled in the art by applying his general knowledge to the implementation of the teaching just disclosed.

1. A method for detecting an anomaly in several predefined areas (A, B) of a single aeronautical part such as a vane, the areas having different structures such as different geometries and/or different materials and/or different thicknesses and/or the presence or absence of a cavity and/or cavities of different sizes, each area (A, B) being associated with at least one predefined view of this area (A, B), the method comprising:
obtaining an image to be inspected (Img) of one of the areas (A, B) according to one of the predefined views of this area (A, B);
supplying the image to be inspected (Img) to a detection system comprising:
a backbone neural network (BB) configured to receive the image to be inspected (Img) and to supply an intermediate representation (RI) of the image to be inspected (Img), and
localization neural networks (LA, LB), respectively associated with the areas (A, B), and each designed, from the intermediate representation (RI), to search for one or more anomalies and to localize each anomaly found in the image to be inspected (Img),
the detection system having been previously trained, for each area (A, B), by supplying, to the backbone network (BB), training images (I*A1, I*A2, I*A3, I*B1, I*B2, I*B3,) according to each predefined view of the area (A, B) in question, and, from the training images (I*A1, I*A2, I*A3, I*B1, I*B2, I*B3,) of the area (A, B) in question, an adaptive adjustment during which parameters of the backbone network (BB) and of the localization network (LA, LB) associated with the area (A, B) in question are adjusted, but not parameters of the one or more other localization networks (LA, LB), in order to improve the detection and the localization; and
obtaining the one or more anomalies and the corresponding localizations at the output of the localization network (LA, LB) associated with the area (A, B) of the image to be inspected (Img).

2. The method according to claim 1, wherein each localization network (LA, LB) is associated with several reference boxes (ANA1, ANA2, ANA3, ANA4, ANB1, ANB2, ANB3) and wherein each localization network (LA, LB) is designed to supply, on the one hand, a position, in the image to be inspected (Img), of one of the reference boxes (ANA1, ANA2, ANA3, ANA4, ANB1, ANB2, ANB3) of the area (A, B) represented on the image to be inspected (Img) and, on the other hand, a probability of presence of anomaly in the reference box (ANA1, ANA2, ANA3, ANA4, ANB1, ANB2, ANB3) at this position.

3. The method according to claim 2, wherein the reference boxes (ANA1, ANA2, ANA3, ANA4, ANB1, ANB2, ANB3) are different for at least one of the localization networks (LA, LB) with respect to the other localization networks.

4. The method according to claim 2, further comprising, for each area (A, B):
determining, in the training images (I*) representing the area (A, B) under consideration, boxes (BOI*A2, BOI*A3, BOI*B1, BOI*B3) surrounding each anomaly previously found in the training images (I*);
clustering the boxes (BOI*A2, BOI*A3, BOI*B1, BOI*B3) into several clusters of similar boxes; and
for each cluster found, determining a reference box (ANA1, ANA2, ANA3, ANA4, ANB1, ANB2, ANB3) from the boxes in the cluster.

5. The method according to claim 4, wherein the reference box (ANA1, ANA2, ANA3, ANA4, ANB1, ANB2, ANB3) determined has dimensions derived from dimensions of the boxes in the cluster.

6. The method according to claim 1, further comprising, for each predefined area (A, B), a classification network (CA, CB) designed to classify, in predefined classes, the anomalies found by the localization network (LA, LB) associated with the area (A, B) in question.

7. The method according to claim 1, wherein the part is a vane comprising a root and a blade, and wherein the predefined areas (A, B) are formed by the root and the blade.

8. The method according to claim 7, wherein the blade has one or more cavities defining a certain percentage of void with respect to the total volume of the blade, this percentage of void being greater than that of the root, it being possible for the percentage of void of the root to be zero, meaning that there is no cavity.

9. The method according to claim 7, wherein the blade and the root have different thicknesses.

10. A computer program (P) which may be downloaded from a communications network and/or recorded on a computer-readable medium, the computer program (P) including instructions for executing the steps of the anomaly detection method according to claim 1 when said program is executed on a computer.

11. An anomaly detection system, comprising:
a backbone neural network (BB) configured to receive an image to be inspected (Img) and to supply an intermediate representation (RI) of the image to be inspected (Img), and
localization neural networks (LA, LB) respectively associated with predefined areas (A, B) of a single part such as a vane, each area (A, B) being associated with at least one predefined view of this area (A, B), the areas having different structures such as different geometries and/or different materials and/or different thicknesses and/or the presence or the absence of a cavity and/or cavities of different sizes, and each configured, from the intermediate representation (RI), to search for one or more anomalies and localize each anomaly found in the image to be inspected (Img),
the detection device having been previously trained, for each area (A, B), by:
a supply, to the backbone network (BB), of training images (I*A1, I*A2, I*A3, I*B1, I*B2, I*B3) according to each predefined view of the area (A, B), and
from the training images (I*A1, I*A2, I*A3, I*B1, I*B2, I*B3) of the area (A, B), an adaptive adjustment during which the parameters of the backbone network (BB) and of the localization network (LA, LB) associated with the area (A, B) are adjusted, but not the parameters of the one or more other localization networks (LA, LB), in order to improve the detection and the localization.

12. The method according to claim 1, wherein the reference boxes (ANA1, ANA2, ANA3, ANA4, ANB1, ANB2, ANB3) are different for at least one of the localization networks (LA, LB) with respect to the other localization networks in number and/or size.
